(19) United States
(12) Patent Application Publication
(10) Pub. No.: US 2008/0171301 A1
(43) Pub. Date: Jul. 17, 2008

(54) DEPTH GAUGE FOR USE IN DENTAL IMPLANTS

(76) Inventor: Emil M. Verban, Bloomington, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/016,061

(22) Filed: Jan. 17, 2008

Related U.S. Application Data
(60) Provisional application No. 60/880,982, filed on Jan. 17, 2007.

(51) Int. Cl. A61C 3/00

(52) U.S. Cl. 433/75

(57) ABSTRACT

A dental drill system and method for drilling a socket to a predetermined depth and diameter which is sized to receive an implant includes a probe portion and a collar threadably disposed on the probe. The probe includes a number of spaced thread sections, wherein each thread section has a margin. Aligning the collar with any one of the thread section margins positions the collar at a desired position. The resulting distance between a tip of the probe and the collar corresponds to a specified depth for a standard implant. The collar is sized and shaped to accurately mimic an implant platform and is used to confirm proper formation of the socket and the resulting orientation of the implant platform before the implant is inserted into the site.

This application claims benefit of U.S. Provisional Patent Application No. 60/880,982, filed Jan. 17, 2007.

### FIELD OF THE INVENTION

The invention relates to the field of Dentistry and more particularly, to the preparation of a site including one or more implant bed or socket for receiving a dental implant. The invention is directed to a depth gauge for providing spatial and visual information related to the depth and orientation of the socket. The gauge includes a probe portion and a collar portion.

### BACKGROUND OF THE INVENTION

Use of endosseous dental implants forming the foundation for various dental restorations, like bridges, crowns, dentures and the like is well known in the art. An example of such an implant is made by Straumann. Other implants are made by Blue Sky Bio and Lifecore, for example.

Straumann implant devices are adapted to integrate into the bone of the implant site and carry a restoration. The devices include a threaded portion. The threaded portion includes a surface prepared and/or formed of a material which permits integration of the implant with surrounding bone material. At one end of the threaded portion is a head or platform, which is highly polished and shaped and adapted to receive a crown or the like. Implant platforms have several diameters. Common platform diameters are 3.5, 4.8 and 6.5 mm.

It will be understood that different implants may have different height platforms. Many of the above implants have a 1.8 mm vertical platform regardless of their diameters.

Positioning of the dental implant is absolutely critical. It is well known that long term success of the implant, and ultimately of the restoration, hinges on drilling a correct placement, diameter, depth and alignment of a socket for receiving the implant. It will be appreciated that this necessitates careful planning as well as careful formation of the socket. In order to make the implant aesthetically pleasing one aspect of the placement involves correct depth placement of the implant so that the platform is perfectly placed, and does not show when the crown is fixed thereto and the surrounding tissue is permitted to assume its natural position.

A conventional and well known method of implanting solid screw implants will be briefly reviewed to provide some background regarding the need for and process of careful preparation of the implant bed. A first step of the procedure involves exposing the bone ridge and preparation of the implant bed for receiving the implant or implants. The ridge is flattened as necessary with a relatively large bur, e.g. a Ø 3.1 mm (3.1 mm diameter) round bur at a maximum of 800 R.P.M. (revolutions per minute). The flattened site may be marked with a small round bur (Ø 1.4 mm) at the center of the intended bore for the socket in which the implant is to be positioned.

After preparation of the site, a pilot hole is formed at the implant site with a pilot drill bit (Ø 2.2 mm) inserted to a depth equal to or slightly deeper than the specified insertion depth of the implant, for example approximately 6.0 mm for a 6 mm implant. Slight pressure should be used during drilling with sufficient cooling throughout the entire sequence.

Conventionally, the depth and alignment of the resulting pilot hole is checked with a Ø 2.2 mm alignment pin. Since the pin is a simple cylinder, it is only possible to estimate how the platform will appear and be oriented relative to the depth being measured by the pin.

Clearly, both angle and depth of the pilot hole must be precise. Since the operation is taking part in the patient mouth, it can be seen that there is an inherent difficulty with this technique, namely, both alignment and depth cannot be accurately gauged at the same time and the final appearance and location of the implant platform can only be estimated and not spatially represented by the current depth pin. While an unsatisfactory implant axis and depth can still be corrected at this step in the procedure it certainly unnecessarily extends and complicates the procedure.

After the alignment of the pilot hole is checked and, if necessary, corrected, drilling continues with the Ø 2.2 mm drill bit to the depth of the implant selected or slightly deeper and the depth is again checked with the Ø 2.2 mm alignment pin. A Ø 2.8 mm drill bit, also known in the industry as a pilot bit, may be used to widen the pilot hole to the appropriate depth. The depth is again checked with a Ø 2.2/2.8 mm depth pin.

If a Ø 3.3 mm reduced diameter or narrow neck implant is being placed, the next step would be to tap the site and insert the implant. If not, a Ø 3.5 mm twist drill bit is used to widen the initial hole to the appropriate depth. The depth is measured with a Ø 3.5 mm depth pin. If a Ø 4.1 mm standard diameter implant is being placed, the nest step would be to tap the site and insert the implant. If not, a Ø 4.2 mm twist drill bit is used and the depth is checked with a Ø 4.2 mm depth pin. The site can then be tapped and a Ø 4.8 mm wide diameter or wide neck implant may be inserted.

As noted, a shortcoming of prior art alignment pins is the difficulty of estimating the position and appearance of the implant platform when the surrounding tissue is permitted to assume its natural position surrounding the platform. It can be appreciated that the alignment pin does not provide a visual confirmation of the ultimate position of the implant, and in particular, the platform position relative to surrounding tissue, and that removing the implant to correct an imprecise placement is not desirable.

It will be understood that the example given herein is illustrative and not limiting in nature. In general, to summarize, the preparation process includes drilling a pilot hole at the implant site at the correct position and angle and then widening the hole with at least a second sized drill to the correct width and depth to receive the implant. The second drill may also be a counterbore type drill in some instances. Further widening of the hole or socket is performed to accommodate a predetermined width and length of the desired implant.

Each implant or post must form a solid, enduring base with sufficient stability to withstand the tremendous mechanical pressure involved in normal chewing, so typically three to six months are allowed for the implant to incorporate into or bond to the bone. During the wait, a temporary bridge or denture is provided to the patient to facilitate eating and to maintain facial muscle support; meanwhile, a lab custom designs and manufactures the restoration to be placed over the implant top(s).

Once the implant post has bonded with the jawbone, and the artificial teeth are ready, the final step of the implant placement process involves placing the prepared restoration(s) over the protruding implant post(s). This results in a secure, attractive, replacement tooth or set of teeth, designed to function as effectively as one's natural teeth. Depending on the number of teeth involved, this final part of the implant process requires only a short time to complete.

Since it is critical to accurately position and angle the socket and since it is critical to prepare the depth of the socket accurately, it can be seen that gauging the angle and depth by eye during drilling and with existing depth gauge pins can be difficult indeed. Furthermore, trying to estimate where the platform of the implant will be located relative to the tissue surrounding the protruding implant platform is difficult with existing depth gauge pins. Thus, there is a demand for a method and device to accurately prepare a socket for receiving a dental implant and gauge accurately the depth and ultimate appearance of the implant and restoration. The present invention satisfies the demand.

### SUMMARY OF THE INVENTION

Now, with the foregoing in mind, the current invention includes aspects directed to a depth gauge for use during preparation of dental implant sockets with one or more drill bit, including a probe portion and a movable stop body or collar threadably disposed on the probe.

The present invention, in perhaps one of its broadest expressions, includes a depth gauge which is usable to gauge the depth and orientation of sockets formed for receiving standard dental implants and provides an accurate gauge for drilling depth as well as the position and orientation of the implant head before the implant is installed.

A probe portion of the depth gauge includes a set of spaced threads. A collar is disposed on the probe and provided with matching threads for engaging the probe threads. Lower margins of the probe threads, in one embodiment, correspond to predetermined distances for setting a desired depth of a drilled implant socket. The collar is the same size as a desired implant platform to be used in the socket being formed for accurate spatial and visual confirmation of correct formation of the socket.

Yet another aspect of the invention provides a method of drilling a socket to a predetermined depth for placement of a dental implant therein and includes the steps of providing a pilot drill bit including a body portion including a first body diameter. A second drill bit is provided with a body portion including a second body diameter corresponding to the predetermined width, wherein the second body diameter is greater than the first body diameter. A depth gauge includes a probe portion and a collar portion. The collar portion is set at a predetermined thread margin corresponding to the depth specification of the implant and inserted into the socket. Visual confirmation is made thereby of correct depth and orientation of the socket. It is a key aspect of the invention that the collar is configured to allow accurate visual confirmation of where the implant platform will be positioned relative to the surrounding tissue. It will also be appreciated that where implants have platforms that vary in vertical height, it is contemplated that the collar of the present invention may be adapted to accurately represent those implant platforms.

The present invention will be further appreciated, and its attributes and advantages further understood, upon consideration of the following detailed description of an embodiment of the invention, taken in conjunction with the accompanying drawings.

### BRIEF DESCRIPTION OF THE DRAWINGS

FIG. 1 shows a depth gauge in a perspective view according to an embodiment of the present invention.

FIG. 2 shows a side view of a probe portion of the depth gauge of FIG. 1.

FIG. 3 shows a side view of a collar portion of the depth gauge of FIG. 1.

FIG. 4 shows a top view of the collar portion shown in FIG. 3.

### DETAILED DESCRIPTION OF AN EMBODIMENT OF THE INVENTION

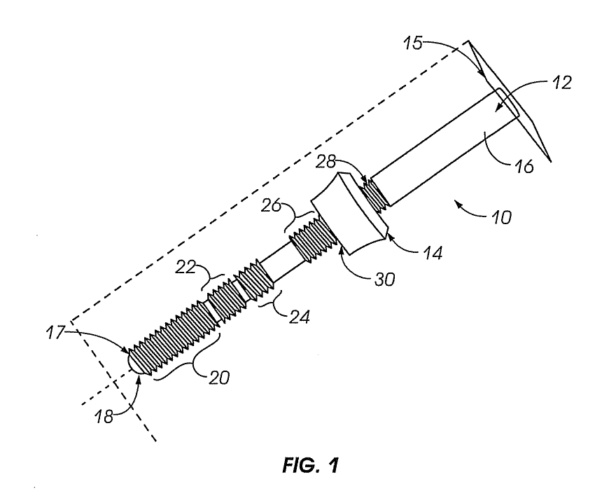

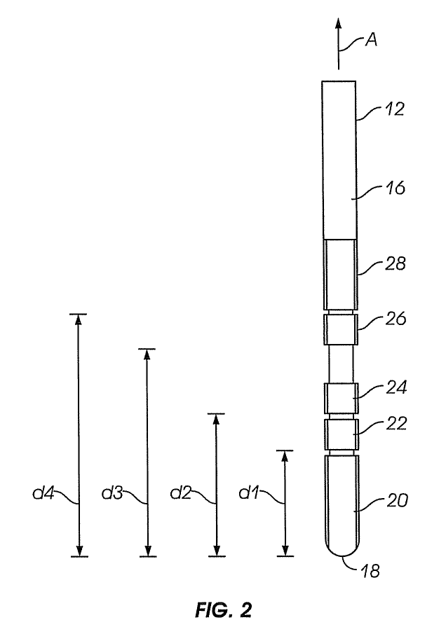

The embodiment of the invention described hereinafter has been particularly adapted for use in the field of Dentistry. The depth gauge shown in FIGS. 1-4 is sized for use in determining the depth and orientation of sockets, and in particular the position of a platform of a selected implant. The socket is formed with, for example, pilot, twist or fluted drill bits in preparing a site for receiving the implant. It should also be noted that the method of forming a pilot hole followed by forming the socket with increasing diameter drill bits proceeds along the same stepwise enlargement of the socket as described above with the additional benefit of use of a depth gauge according to the present invention. For example, an embodiment of the invention involves a method including drilling a pilot hole using a 2.2 mm pilot drill bit followed by a 2.8 mm drill bit. The illustrated depth gauge includes a collar with a diameter which matches (within about 0.01 mm) the diameter of the platform of a selected implant (e.g., 4.8 mm). The collar is adjusted to a position on the gauge identical to a platform of a desired implant.

Referring to the drawings, FIG. 1-4 shows a depth gauge 10, including a probe portion 12 and a collar portion 14. The probe portion 12 is generally cylindrical in shape. The probe portion 12 includes a handle section 16 at one end (proximal end 15) and a tip 18 formed at an opposite end (distal end 17) of the handle.

The probe 12 has a number of spaced threads formed on the outside thereof between the handle 16 and the tip 18. An important aspect of the invention is the position of these threaded sections. One example of how the threaded sections are positioned on the probe 12 is provided. It will be understood that other schemes may be used to arrange threaded sections on the probe 12. As will be explained more fully below, the threaded sections are arranged to provide a means of positioning the collar 14 at predetermined distances from the tip 18 to index the gauge to desired implant specifications. This arrangement provides for simple and accurate determination and improved spatial and visual inspection of the socket being formed. This is due at least in part because the collar so indexed to the proper threaded section will provide an accurate reference to the user as to correct position of the implant, and especially the implant platform relative to surrounding tissue.

Returning to FIG. 1, the sections include a first threaded section 20, which extends inwardly from the tip 18. A second threaded section 22 extends along probe 12 from the first threaded section 20. The second threaded section 22 is spaced from section 20 by a distance of 0.25 mm. A third threaded section 24 extends along probe 12 from the second threaded section 22 and is spaced therefrom by a distance of 0.25 mm. A fourth threaded section 26 extends along probe 12 from the third threaded section 24 and is spaced a distance of 2.12 mm therefrom. A fifth threaded section 28 extends along probe 12 from the fourth threaded section 26 and is spaced therefrom a distance of 0.25 mm.

The bottom of the second threaded section 22 begins 6 mm from the tip 18 (d1). The bottom of the third threaded section 24 begins 8 mm from the tip 18 (d2). The bottom of the fourth threaded section 26 begins 12 mm from the tip 18 (d3). The bottom of the fifth threaded section 28 begins 14 mm from the tip 18 (d4). Overall the probe section 12 is about 27 mm long along the axial direction (A) and 2 mm in diameter (radial).

Preferably, the parts of the depth gauge 10 is formed of 304 stainless steel, as stainless steel can be sterilized and reused, but it will be appreciated that any number of materials may be used such as other types of stainless steel, steel, aluminum, and titanium, alloys of various metals and/or materials, ceramics, plastic materials, combinations thereof, composites or any other suitable material.

The distances from each of the bottom portion of each threaded section to the tip 18 correspond to common implant specifications. In other words, positioning the collar 14 to the bottom of one of the threaded sections sets the distance between the bottom surface 30 of the collar 14 a predetermined distance from the tip 18. The threaded section chosen determines the distance. The distances correspond to common specified depth requirements of common implants. It will be understood that the threaded sections or other dimensions of the gauge 10 can be modified to adapt the invention to other implants. In other words, the illustrated embodiment is structurally adapted to provide predetermined spatial and visual reference when in position by providing indexed positioning of the collar 14 relative to the probe 12 tip 18 at distances corresponding to standard implants with depth requirements of 6 mm, 8 mm, 12 mm and 14 mm. Other distances are contemplated by the invention.

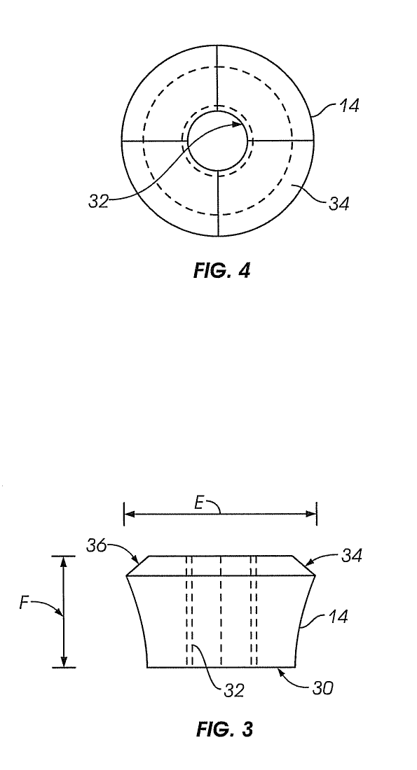

Referring in particular to FIGS. 3 and 4, the collar 14 is an annular or circular nut having internal threads 32 matching with those of the probe 12. The diameter (E) of the collar 14 can be made to be 4.79 mm, which corresponds to the diameter of a common implant platform. Different collar diameters E can be provided to correspond to other platform diameters as noted above. The invention contemplates a plurality of different diameter collars 14 interchangeably usable with a probe 12. The axial length F of the collar 14 can be made to be about 2.79 mm. The collar 14 also has a bevel or chamfer, formed at about 45 degrees, referred to as a margin 34 on an upper surface 36 of the collar which may correspond to the shape of a similar feature on the upper surface of the implant platform.

While the present invention has been described with respect to a particular embodiment, those of skill in this art will recognize even more variations, applications and modifications which will still fall within the spirit and scope of the invention, all as intended to come within the ambit and reach of the following claims.

What is claimed is:

1. A depth gauge, comprising:
a probe, the probe including a tip portion and a handle portion, wherein the tip includes a plurality of threaded sections, each of the threaded sections being separated by non-threaded sections; and
a collar including internal threads sized and shaped to engage the probe and adjust along the plurality of threaded sections.

2. The depth gauge of claim 1, wherein the plurality of threaded sections includes a first threaded section which extends a distance inwardly from the tip portion and a second threaded section spaced from the first threaded section by a non-threaded section.

3. The depth gauge of claim 2, wherein the plurality of threaded sections further includes a third threaded section which is spaced from the second threaded section by a non-threaded section therebetween, and a fourth threaded section spaced from the third threaded section by a non-threaded section therebetween.

4. The depth gauge of claim 3, wherein the plurality of threaded sections includes a fifth threaded section which is spaced from the fourth threaded section by a non-threaded section therebetween.

5. The depth gauge of claim 1, wherein the collar portion is sized and shaped to the same dimensions as a platform of a predetermined dental implant platform.

6. The depth gauge of claim 2, the distance from the tip portion to the bottom of the second threaded section is 6 mm.

7. The depth gauge of claim 3, the distance from the tip portion to the bottom of the third threaded section is 8 mm.

8. The depth gauge of claim 3, the distance from the tip portion to the bottom of the fourth threaded section is 12 mm.

9. The depth gauge of claim 4, the distance from the tip portion to the bottom of the fifth threaded section is 14 mm.

10. The depth gauge of claim 1, wherein the non-threaded sections are about 0.25 mm in length.

11. A system for drilling a socket to a predetermined depth and diameter which is sized to receive an implant, wherein the system includes at least one drill bit having a first bit diameter, the system comprising:
a depth gauge, comprising a probe, the probe including a tip portion and a handle portion, wherein the tip includes a plurality of threaded sections, each of the threaded sections being separated by non-threaded sections, wherein one of the plurality of threaded sections includes a bottom section corresponding in distance from the tip portion to the predetermined depth; and
a collar including internal threads sized and shaped to engage the probe and adjust along the plurality of threaded sections.

12. The system of claim 11, wherein the collar has a diameter about the same as that of a platform of a selected predetermined implant.

13. The system of claim 11, further including a plurality of collars, wherein each of the plurality of collars includes internal threads sized and shaped to engage the threaded sections of the probe, and each of the plurality of collars has a diameter corresponding to different sized platforms of a plurality of selected predetermined implants.
